(19) United States
(12) Patent Application Publication
(10) Pub. No.: US 2009/0060794 A1
(43) Pub. Date: Mar. 5, 2009

(54) Eccentric rotating device

(76) Inventors: Chien Fa Wang, Taipei (TW); Wen Liang Chuu, Taoyuan (TW); Tu Cherng Jang, Taipei (TW)

Correspondence Address: SAM CHEN, 7F-1, 293, ROOSEVELT ROAD, SEC 3, TAIPEI, TW

(21) Appl. No.: 11/850,673

(22) Filed: Sep. 5, 2007

(51) Int. Cl. B01L 11/00

(52) U.S. Cl. 422/99

(57) ABSTRACT

A motor driven rotating device is disclosed that includes a fixed base, an eccentric rotating mechanism above the base, first magnets in the base, and second magnets in the rotating mechanism. A polarity of each first magnet is opposite to that of each second magnet so as to maintain a gap between the base and the rotating mechanism. Also, the rotating mechanism is adapted to eccentrically rotate.

### BACKGROUND OF THE INVENTION

1. Field of Invention

The invention relates to rotating devices and more particularly to such a rotating device having an eccentric rotating mechanism adapted to suspend relative to a base by magnetic rejection force.

2. Description of Related Art

Conventionally, test tubes are widely used in chemical laboratories. In one chemical experiment, liquid contained in two or more test tubes are required to pour into a large test tube for mixing in order to form a new solution. Typically, a rotating device is employed for rotating the large test tube in order to uniformly mix the liquid.

However, commercially available rotating devices are typically relatively complex in constructions, costly to manufacture, trouble-prone, and unreliable in use. Thus, the need for improvement still exists.

### SUMMARY OF THE INVENTION

It is therefore one object of the invention to provide an eccentric rotating device having an eccentric rotating mechanism adapted to suspend relative to a base by magnetic rejection force.

The above and other objects, features and advantages of the invention will become apparent from the following detailed description taken with the accompanying drawings.

### BRIEF DESCRIPTION OF THE DRAWINGS

FIG. 1 is an exploded view of a preferred embodiment of eccentric rotating device according to the invention;

FIG. 2 is a perspective view of the assembled rotating device;

FIG. 3 is a longitudinal sectional view of the rotating device of FIG. 2;

FIG. 4 is a cross-sectional view of a portion of the rotating device of FIG. 2;

FIG. 5 is another perspective view of the rotating device being in operation with the transmission mechanism being shown in detail; and

FIG. 6 is a view similar to FIG. 2 where the rotating device is operating.

### DETAILED DESCRIPTION OF THE INVENTION

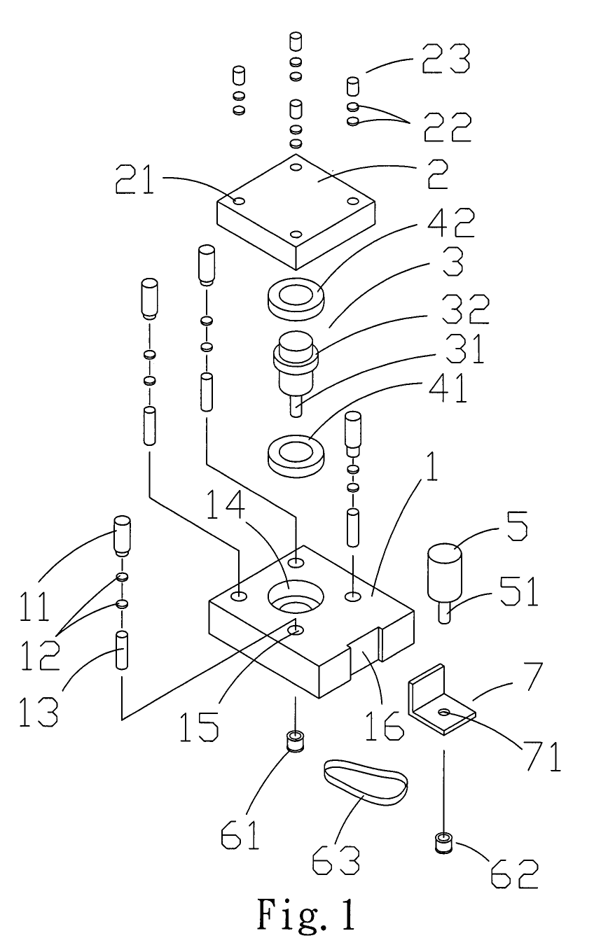

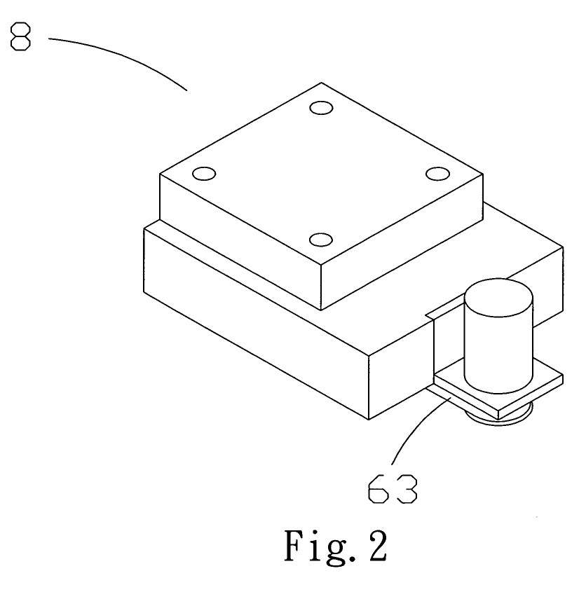

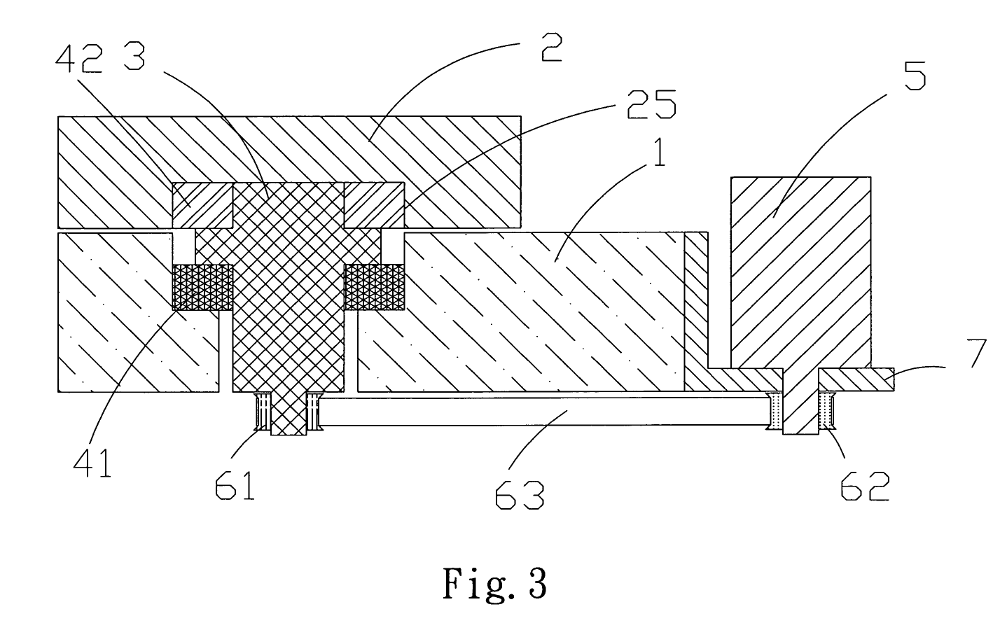

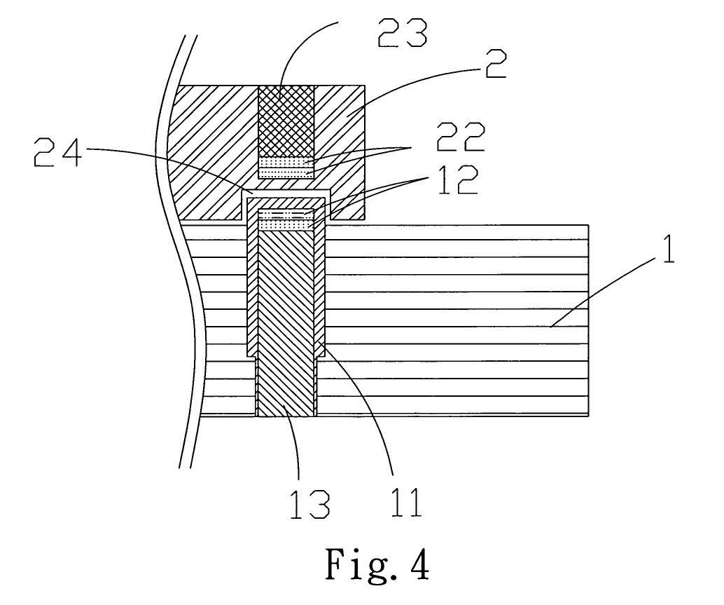

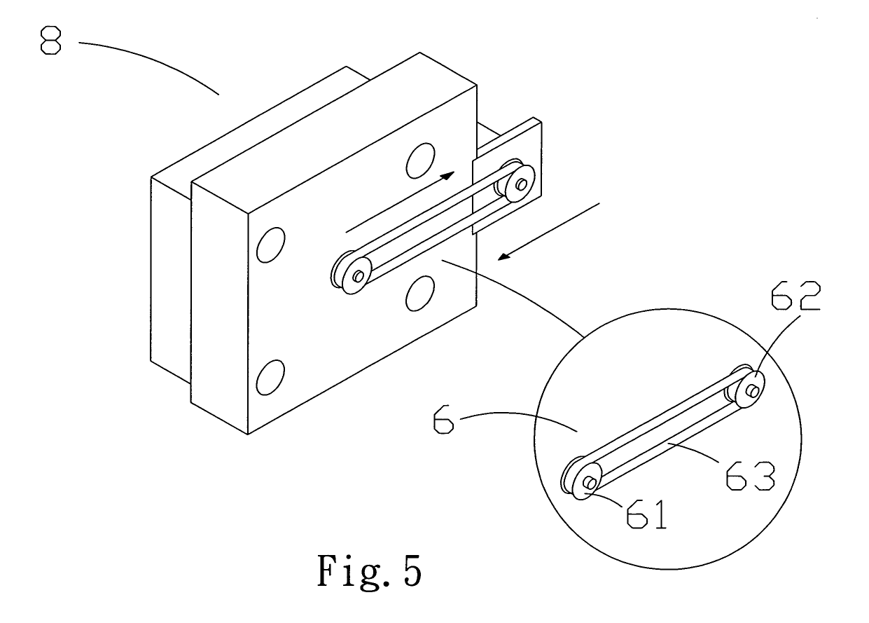

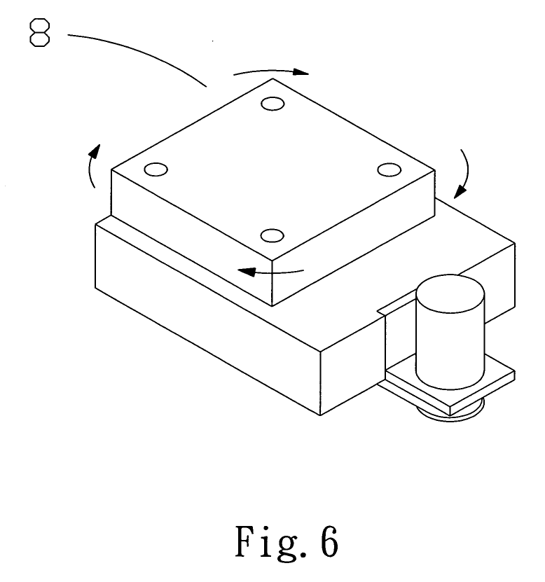

Referring to FIGS. 1 to 6, an eccentric rotating device 8 in accordance with a preferred embodiment of the invention comprises a base 1, a rotating mechanism 2, a shaft 3, a fastening mechanism including first and second bearings 41, 42, a motor 5, a transmission mechanism 6, and a coupling member 7. Each component is discussed in detail below.

The base 1 is a parallelepiped and comprises a staged longitudinal channel 14 open to both top and bottom surfaces, four staged through holes 15 arranged as a square and disposed around the channel 14, a recess 16 at one side, four sets of a holed member 11, two first magnets 12, and a first bar 13 in which for each set the holed member 11 is disposed in the hole 15 with its top slightly projecting out of the top surface of the base 1, the first magnets 12 are disposed in the blind end of the hole of the holed member 11, and the first bar 13 is also disposed in the blind end of the hole of the holed member 11 to be engaged with the lower one of the first magnets 12.

The first bearing 41 is of ring shaped and is seated upon the shoulder of the channel 14. The shaft 3 is put into the channel 14 to seat upon the first bearing 41 in which the shaft 3 has a bottom projection 31 projecting out of the bottom surface of the base 1. The second bearing 42 is also of ring shaped and is seated upon an intermediate annular member 32 of the shaft 3.

The rotating mechanism 2 is a parallelepiped and comprises four holes 21 at four corners respectively, four sets of two second magnets 22 and a second bar 23 in which for each set the second magnets 22 are disposed in the blind end of the hole 21 and the second bar 23 is fastened in the hole 21 with its bottom urged against the top one of the second magnets 22, four bottom wells 24 of circular section aligned with the holes 15 in an inoperative position, and a bottom cavity 25 of circular section aligned with the channel 14. An upper portion of the shaft 3 and the first bearing 42 are fastened in the cavity 25. A top portion of the holed member 11 slightly projects out of the top surface of the base 1 to be disposed in the well 24. The polarity of each first magnet 12 is opposite to that of each second magnet 22. Hence, in this embodiment there is a 5 mm gap between the base 1 and the rotating mechanism 2. Also, the top portion of the holed member 11 is not engaged with the well 24 due to magnetic rejection.

The coupling member 7 is of L-shaped and has its vertical portion fastened in the recess 16. The motor 5 has a driving shaft 51 fitted through a through hole 71 on a horizontal portion of the coupling member 7 so that the motor 5 may seat upon the horizontal portion of the coupling member 7. The transmission mechanism 6 comprises a first wheel 61 secured onto the projection 31, a second wheel 62 secured onto the driving shaft 51, and a belt 63 run around grooved rims of the wheels 61, 62.

An operation of the invention will be described in detail below. The second wheel 62 rotates when the motor 5 is activated. And in turn, the first wheel 61 rotates by the running belt 53. Thus, the shaft 3 rotates eccentrically with its center offset about 2 mm. As a result, the rotating mechanism 2 rotates in a path similar to an ellipse with the base 1 being fixed. It is also noted that the opposite polarities of the magnets 12, 22 cause the rotating mechanism 2 to maintain in a position above the base 1 while rotating. This has the advantage of preventing the rotating mechanism 2 from contacting the base 1 in rotation. That is, the rotating mechanism 2 suspends relative to the base 1. Note that the gap between the base 1 and the rotating mechanism 2 can be adjusted by increasing or decreasing the number of magnets 12, 22.

While the invention herein disclosed has been described by means of specific embodiments, numerous modifications and variations could be made thereto by those skilled in the art without departing from the scope and spirit of the invention set forth in the claims.

What is claimed is:

1. A rotating device (8) comprising:
a base (1) comprising a staged longitudinal channel (14) open to both top and bottom surfaces, a plurality of staged through holes (15) arranged as a rectangle and disposed around the channel (14), a recess (16) at one side, a plurality of first sets of a holed member (11), a plurality of first magnets (12), and a first bar (13) wherein for each first set the holed member (11) is disposed in the through hole (15) with its top projecting out of the top surface of the base (1), the first magnets (12) are disposed in a blind end of the holed member (11), and the first bar (13) is disposed in the blind end of the holed member (11) to be engaged with the lower one of the first magnets (12);
a ring shaped first bearing (41) seated in the channel (14);
a shaft (3) disposed in the channel (14) to seat upon the first bearing (41), the shaft (3) having an intermediate annular member (32) and a bottom projection (31) projecting out of the bottom surface of the base (1);
a ring shaped second bearing (42) seated upon the annular member (32);
a rotating mechanism (2) comprising a plurality of holes (21) arranged as a rectangle, a plurality of second sets of a second bar (23) and a plurality of second magnets (22) wherein for each second set the second magnets (22) are disposed in a blind end of the hole (21) and the second bar (23) is fastened in the hole (21) with its bottom urged against the top second magnet (22), a plurality of bottom wells (24) of circular section each aligned with the through hole (15) and the hole (21) and disposed therebetween in an inoperative position, and a bottom cavity (25) of circular section aligned with the channel (14) wherein an upper portion of the shaft (3) and the first bearing (42) are fastened in the cavity (25), a top portion of each of the holed members (11) projects out of the top surface of the base (1) to be disposed in the well (24);
an L-shaped coupling member (7) comprising a vertical portion fastened in the recess (16) and a horizontal portion having a through hole (71);
a motor (5) seated upon the horizontal portion of the coupling member (7) and having a driving shaft (51) disposed through the through hole (71); and
a transmission mechanism (6) comprising a first wheel (61) secured onto the projection (31), a second wheel (62) secured onto the driving shaft (51), and a belt (63) run around the first and the second wheels (61, 62),
wherein a polarity of each of the first magnets (12) is opposite to that of each of the second magnets (22) so as to maintain a gap between the base (1) and the rotating mechanism (2); and
wherein in response to activating the motor (5) both the first and the second wheels (61, 62) rotate in cooperation with the running belt (53) to eccentrically rotate both the shaft (3) and the rotating mechanism (2).

2. The rotating device (8) of claim 1, wherein the gap between the base (1) and the rotating mechanism (2) is about 5 mm.

3. The rotating device (8) of claim 1, wherein the number of the holes (21), the through holes (15), or the wells (24) is four, and wherein the number of the first sets or the second sets is four.
